(19) United States
(12) Patent Application Publication
(10) Pub. No.: US 2009/0182897 A1
(43) Pub. Date: Jul. 16, 2009

(54) METHOD AND APPARATUS THAT PROVIDES TARGETED HTTP DELIVERIES FOR USERS WITHIN A PRIVATE NETWORK

(76) Inventors: Zachary Edward Britton, Toulumne, CA (US); Derek Stephen Maxson, Twain Harte, CA (US)

Correspondence Address: ROBROY R FAWCETT, 1576 KATELLA WAY, ESCONDIDO, CA, 92027, US

(21) Appl. No.: 12/350,321

(22) Filed: Jan. 8, 2009

Related U.S. Application Data
(60) Provisional application No. 61/010,821, filed on Jan. 10, 2008.

(51) Int. Cl. G06F 15/16

(52) U.S. Cl. 709/245

(57) ABSTRACT

The present invention enables a NSP to customize content to any number of user profiles, instances, browsers or computers including systems that are located behind a NAT network. It solves the persistent issues that multiple users and NAT networks present to the NSP who does not have view into the individual computers located on the NSP network. In addition to enabling the full revenue potential of a network, the invention enables the targeting of any customer service content to be delivered.

### CROSS-REFERENCE TO RELATED APPLICATION

This application claims the benefit of U.S. Provisional Application No. 61/010,821, filed on Jan. 10, 2008, which application is incorporated herein by reference.

### BACKGROUND OF THE INVENTION

1. Field of the Invention

The present invention relates generally to a method and apparatus to target individual users who are located within a private network segment attached to a local area network.

2. Description of the Prior Art and Related Information

As the Internet continues to grow and evolve, targeting content and advertising to the prior behavior of the individual is an increasingly common and valuable methodology for shaping the user experience. As referenced in Slemmer (U.S. Pat. No. 6,226,677), there is a method for using an intermediate device such as a forced proxy to insert custom content. In addition, Britton (U.S. Pat. No. 6,442,577) provides for targeting this content according to several criteria.

However, the proliferation of home networking, hot spots, hot zones and other networks that utilize Network Address Translation (NAT), has decreased the viability of the above methods.

Network Address Translation is the method by which one publicly addressable IP address may be shared by more than one computer or computer device behind a router or other device used to perform NAT and to provide access control. Each client computer has a private IP address that is not visible to any device on the outside of the NAT network. Thus, a device such as in Slemmer would not be able to determine the number of users and computers behind a single IP address.

In addition, if the custom content to be served is advertising, then Slemmer and in some cases Britton are not able to target these custom messages to the potentially numerous computers located behind a NAT-enabled router. Therefore network operators are not realizing the full revenue potential of the advertising on the network.

Also, many computers now host distinct profiles for various members of a household wherein a single computer may have distinct identities for an adult member of the family, a teenager and a younger child. Since each user has distinct patterns and behavior, it is similarly not possible to target using the Slemmer and Britton methods.

The submitted invention is a method for extending the Britton and Slemmer functionality in order to target specific content to the individual profile or computer even if that device is located behind a NAT.

### SUMMARY OF THE INVENTION

To address the shortcomings of the prior art, the present invention provides a new method for identifying and targeting HTTP content to individual computers located within a NAT network.

The existing techniques as referred in both Britton and Slemmer use the IP address available to the detecting device—a web server or intermediate server such as a proxy.

The present invention is able to detect the individual computers or computer devices represented by one IP address on the network through the inventive placement of cookies onto the browser instances of each individual computer.

When an individual computer makes an HTTP request, the NAT router will translate the source IP address and port of the original HTTP request to be the IP address of the NAT group, the request may then be serviced by other local devices such as in Slemmer and in some instances of Britton. At this point, the present invention may choose to modify a response to the client causing a new web request to be made by the computer to a different web server. This web server will inspect the cookie delivered in the request (if any) and will insert or modify the cookie if desired. If the conditions are correct for customizing the content to be delivered to the originating computer, the web server may insert this content or redirect to one or more web servers for the delivery of custom content.

In addition, this present invention allows for the use of other client identification or storage methods such as Flash to be used instead of cookies.

In addition, this present invention provides for the tagging of each browser instance with a GUID (globally unique identification) number that will be the primary key to identify unique users located behind the NAT.

In addition, this present invention provides that a download of software may be used to further identify the users located behind the NAT.

In addition, this present invention provides a method to ensure that any one user does not receive customized content at inappropriate times or too frequently than is desired.

The present invention also provides the apparatus for performing the corresponding methods as recited above.

### BRIEF DESCRIPTION OF THE DRAWINGS

The aforementioned advantages of the present invention as well as additional advantages thereof will be more clearly understood hereinafter as a result of a detailed description of a preferred embodiment of the invention when taken in conjunction with the following drawings.

FIG. 1 depicts a flowchart illustrating the process of customizing the content delivered to computers (NAT Detection and Content Customization Flow Chart).

FIG. 2 depicts an exemplary network system, in which the present invention can function (Network Service Provider Diagram).

FIG. 3 depicts an exemplary user database for the present invention.

FIG. 4 depicts an exemplary Web page database for the present invention.

FIG. 5 depicts an exemplary cookie containing identification and service parameters.

FIG. 6 depicts an exemplary NAT process (Sample NAT Diagram).

FIG. 7 depicts an exemplary inserted Web page created by the present invention (Sample Customized Content).

FIG. 8 depicts and exemplary computer with multiple profiles.

### DETAILED DESCRIPTION

The present invention discloses novel methods and apparatuses for an ISP (internet or network service provider) to direct Internet Web traffic to the Web site it wishes to promote.

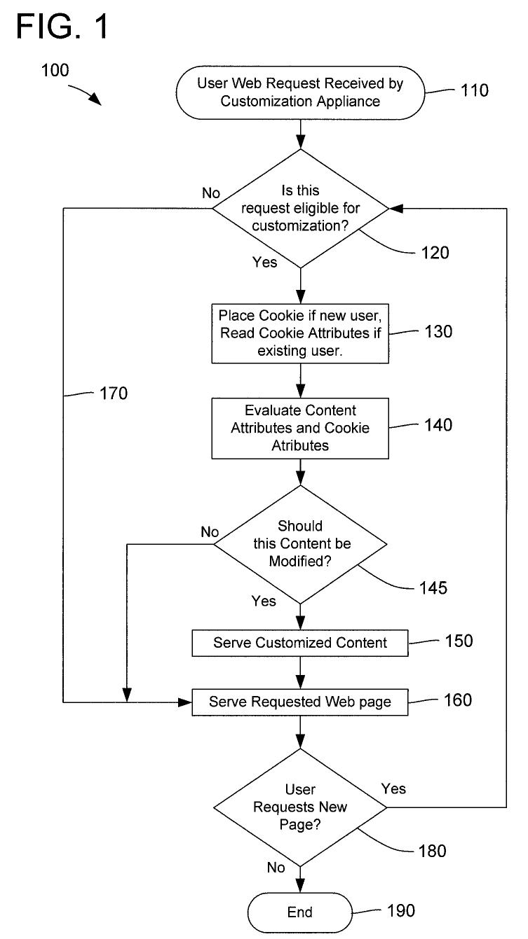

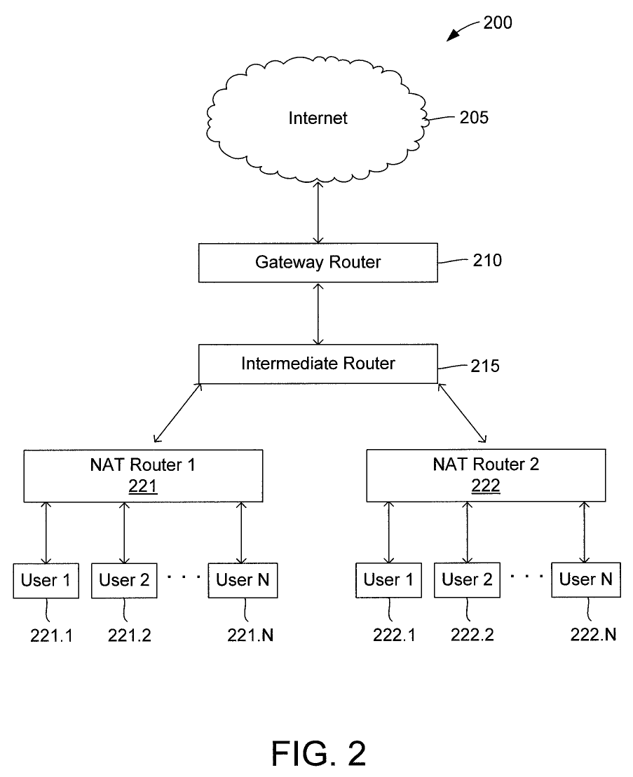

FIG. 1 depicts a flowchart illustrating the process of customizing web content, in accordance with the present invention. In describing FIG. 1, it is assumed that:
1. the Internet user is connected to the Internet through a network service provider NSP (exemplified in FIG. 2) that utilizes the invention;
2. there are one of more networks of NAT routers which each contain one or more unique computers or computer devices;
3. there is an intermediate server capable of redirecting web requests; and
4. there is a customization web server capable which utilizes this invention.

In FIG. 1, the web request has been redirected by the intermediate server (FIG. 2, step 215) to the customization routine.

At step 110, the web request has been received by the customization routine.

At step 120, the application checks fields 410 and 420 in database 400 to ascertain if the web page redirected in step 100 is eligible for customization. If it is eligible, proceed to step 130 otherwise proceed to step 160 via path 170.

At step 130, the application checks for the presence of a cookie in the web request. If none is found, a GUID is generated and offered to the computer.

At step 140, the application checks fields in database 300 to ascertain the usage parameters from the database. The cookies is read and the attributes are available to the customization routine.

At step 145, the application checks all of its available data and parameters according to the business rules established to determine if this web request should be customized. If the content should be modified, proceed to step 150 otherwise proceed to step 160.

At step 150, the application serves the customized content determined in step 145.

At step 160, the application may serve the original requested content to the user.

At step 180, if the user requests another Web page, the user is sent to step 120. If the user does not request another Web page, the session ends (step 190).

At step 190, the user is no longer requesting Web pages and there is no more interaction with the invention.

FIG. 2 depicts a block diagram illustrating an exemplary network 200, which includes one or more Internet users connected via NAT networks to the Internet via NSPs. The users (221.1-221.N and 222.1-222.N) web requests are handled first by the NAT device (221 and 222), secondarily by the intermediate server (215) prior to be routed (210) to the Internet (205).

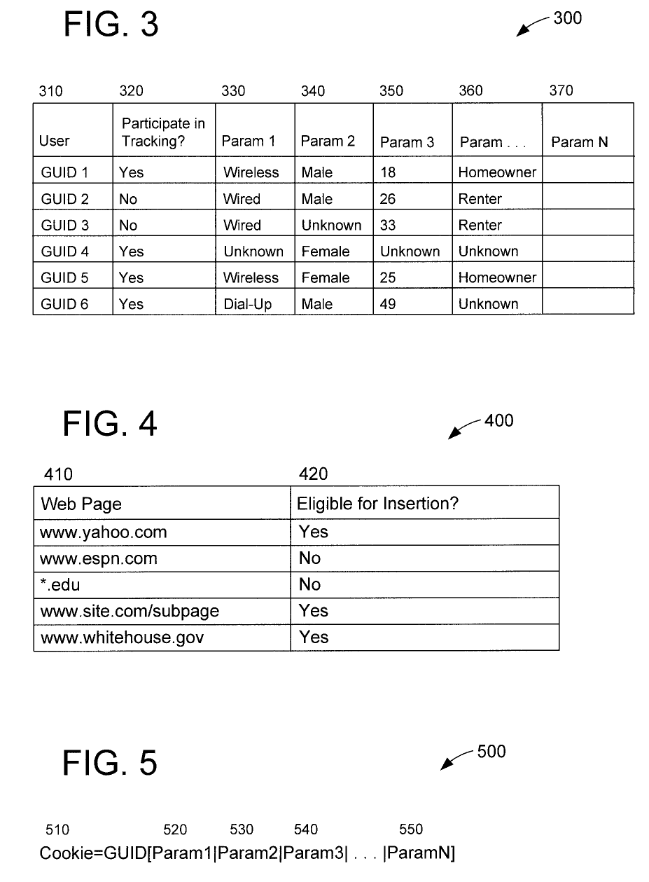

FIG. 3 depicts an exemplary user database 300 located at a NSP (or, alternatively, it can be located off-site on a separate network) (which can be any one of the nodes 221-222) for storing user identification and participation information, in accordance with the present invention. Use of this database is optional, as noted in the description of FIG. 1.

The participant database 300 (which runs on a computer system as shown in FIG. 2) has four fields:
1. a User field, 310, containing the GUID or some other appropriate date element that would represent a unique computer or browser on the network;
2. a Participation field, 320, detailing whether the user is participating in the tracking; and
3. a series of parameter fields, 330-370 which may be used to store criteria about the user's identity, behavior, location or other similar data. Many parameter fields could be used, or none at all, depending upon the implementation of the invention.

FIG. 4 depicts an exemplary Web page database 400 located at a NSP (or, alternatively, it can be located off-site on a separate network) (which can be any one of the nodes 221-222) for storing Web site participation information, in accordance with the present invention. Use of this database is optional, as noted in the description of FIG. 1.

The Web page database 400 (which runs on a computer system as shown in FIG. 2) has two fields:
1. a Web Page field, 410, containing the Web page name; and
2. an Eligibility field, 420, detailing whether the Web page is eligible for insertion.

FIG. 5 depicts a block diagram illustrating an exemplary inserted cookie for storing individual customization data.

The exemplary cookie may contain similar information as is stored in database 300 but must contain at least the GUID or other unique identifier within the network. It contains:
1. a User field, 510, containing the GUID or some other appropriate date element that would represent a unique computer or browser on the network; and
2. a series of parameter fields, 520-550 which may be used to store criteria about the user's identity, behavior, location or other similar data. Many parameter fields could be used, or none at all, depending upon the implementation of the invention.

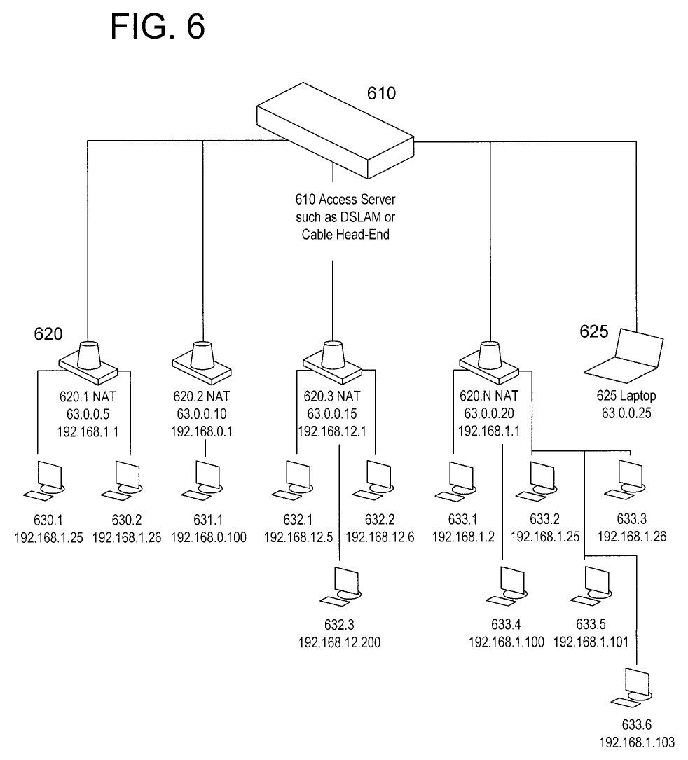

FIG. 6 depicts an exemplary network diagram with several NAT-enabled routers connected to it with several computers connected on those networks:
1. an Access Server, 610, such as a DSLAM, cable head-end, switch, terminal server, wireless gateway or similar device to aggregate network traffic;
2. several NAT router gateway devices, 620.1-620.4 wherein each router has an an IP Address known to the Access Server such as the example of 63.0.0.5;
3. an exemplary laptop, 625, which is not accessing the network through NAT and has an IP Address known to the Access Server such as 63.0.0.25; and
4. several computers, 630.1-633.6, connected to the various NAT routers which all have various and, in some cases the same, IP Addresses such as 192.168.1.25 (these IP addresses are not know to the Access Server).

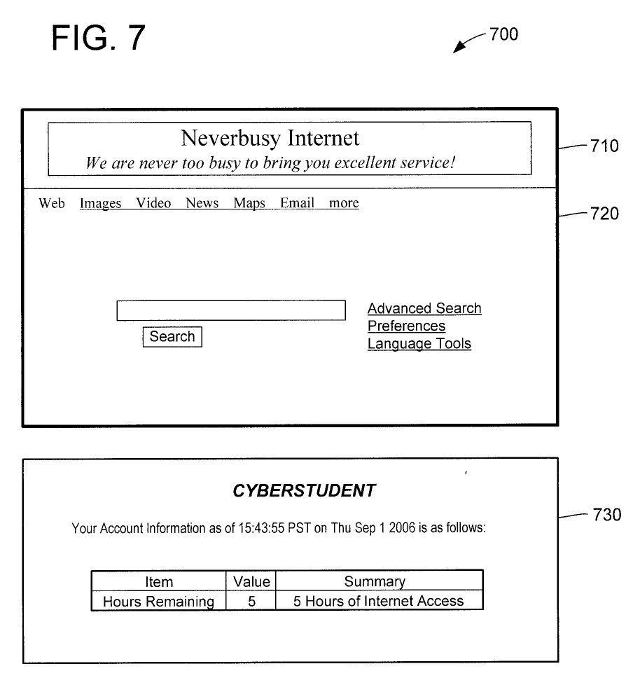

FIG. 7 depicts some sample customized content provided using the present invention. In Slemmer and some instances of Britton, this message would be able to be sent to an IP Address such as 625 but only to one of 633.1-633. The present invention allows the content to be served to each unique browser instance regardless of how many users and computers are utilizing a specific IP Address. The sample customized content may include:
1. a sample customized banner advertisement, 710, placed upon another web site, 720, using the present invention; and
2. a sample customized message informing the owner of the account in regard to time available on the account 730. With the present invention, this message could be uniquely served to each user behind the NAT thus ensuring its delivery to the account owner (otherwise in Slemmer, the message may not be viewed by the account owner, but only perhaps to a guest or a child).

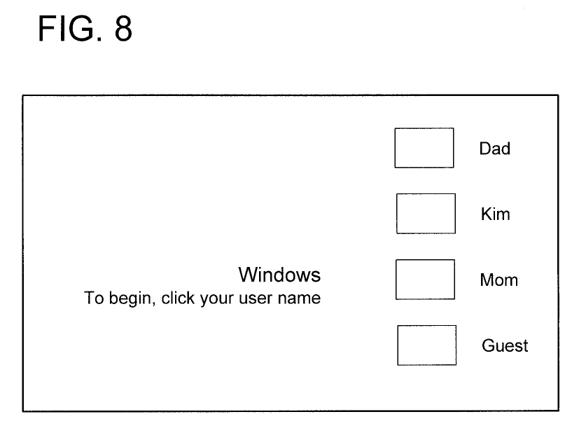

FIG. 8 depicts an exemplary computer with separate profiles for different individuals that utilize the computer. Each profile represents distinct Internet surfing behavior.

While the invention has been illustrated and described in detail in the drawings and foregoing description, it should be understood that the invention may be implemented through alternative embodiments within the spirit of the present invention. Thus, the scope of the invention is not intended to be limited to the illustration and description in this specification, but is to be defined by the appended claims.

What is claimed is:

1. A method for providing targeted content, comprising:
using a cookie implemented by a network service provider to establish a unique identifier for an instance of an internet user client accessing the internet though the network service provider and through a network using network address translation (NAT);
accessing the unique identifier using the cookie; and
providing content targeted to the internet user client based on information associated with the unique identifier.

2. A method for providing targeted content as defined in claim 1, wherein the information associated with the unique identifier is user profile information.

3. A method for providing targeted content as defined in claim 1, wherein the information associated with the unique identifier is usage history information.

4. A method for providing targeted content as defined in claim 1, wherein the information associated with the unique identifier is stored as a parameter of the cookie.

5. A method for providing targeted content as defined in claim 1, wherein the information associated with the unique identifier is stored in a database of a server.

6. A method for providing targeted content as defined in claim 1, wherein the network service provider provides access to the internet to the internet user client through a gateway.

7. An apparatus for providing targeted content, comprising:
means for using a cookie implemented by a network service provider to establish a unique identifier for an instance of an internet user client accessing the internet though the network service provider and through a network using network address translation (NAT);
means for accessing the unique identifier using the cookie; and
means for providing content targeted to the internet user client based on information associated with the unique identifier

8. An apparatus for providing targeted content as defined in claim 7, wherein the information associated with the unique identifier is user profile information.

9. An apparatus for providing targeted content as defined in claim 7, wherein the information associated with the unique identifier is usage history information.

10. An apparatus for providing targeted content as defined in claim 7, wherein the information associated with the unique identifier is stored as a parameter of the cookie.

11. An apparatus for providing targeted content as defined in claim 7, wherein the information associated with the unique identifier is stored in a database of a server.

12. An apparatus for providing targeted content as defined in claim 7, wherein the network service provider provides access to the internet to the internet user client through a gateway.

13. A computer program product, comprising:
computer readable medium including:
code for causing a computer to use a cookie implemented by a network service provider to establish a unique identifier for an instance of an internet user client accessing the internet though the network service provider and through a network using network address translation (NAT);
code for causing a computer to access the unique identifier using the cookie; and
code for causing a computer to provide content targeted to the internet user client based on information associated with the unique identifier.

14. A computer program product as defined in claim 13, wherein the information associated with the unique identifier is user profile information.

15. A computer program product as defined in claim 13, wherein the information associated with the unique identifier is usage history information.

16. A computer program product as defined in claim 13, wherein the information associated with the unique identifier is stored as a parameter of the cookie.

17. A computer program product as defined in claim 13, wherein the information associated with the unique identifier is stored in a database of a server.
